(19) United States
(12) Patent Application Publication
(10) Pub. No.: US 2011/0029740 A1
(43) Pub. Date: Feb. 3, 2011

(54) COMMUNICATING METHOD APPLIED FOR STORAGE DEVICE

(76) Inventors: Chia-Hsiung Lee, Taoyuan County (TW); Cheng-Wei Lu, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/626,938

(22) Filed: Nov. 30, 2009

(30) Foreign Application Priority Data
Jul. 28, 2009 (TW) 098125313

(51) Int. Cl. G06F 12/00; G06F 3/00

(52) U.S. Cl. 711/154; 710/5; 711/170; 711/E12.001; 711/E12.002

(57) ABSTRACT

A communicating method between a storage device and an application program includes the following steps: the application program dynamically selects a block address in the storage device as a predetermined block address; and the application program performs a command write-in or state read-out process via the predetermined block address to communicate with the storage device.

### BACKGROUND OF THE INVENTION

1. Field of the Invention

The present invention relates to a communicating method between a storage device and an application program, and more particularly, to a communicating method which dynamically selects a block address in a storage device to act as a communicating means between the storage device and an application program.

2. Description of the Prior Art

Generally speaking, in a computer system, an application program has to establish a communication mechanism with a storage device before performing a custom command upon the storage device or retrieving the operational state of the storage device. In the prior art design, the application program will utilize an in-band approach to make the controller of the storage device fix a communication sector address first. Then, the application program can communicate with the storage device via the communication sector address. Or the application program will utilize an out of band approach to communicate with the controller of the storage device, the application program can communicate with the storage device via other specific transmission interface without fixing a communication sector address. However, the prior art design has many problems and disadvantages. For example, when the communication is realized via the out-of-band approach, the commands issued from the application program have to fit the signal format of the transmission interface in the storage device; that is, the host system to which the storage device is attached has to add the hardware which supports the transmission interface, and then perform the out-of-band communication via a transmission line. This will increase the cost of the storage device.

On the other hand, when the communication is realized via the in-band approach, the application program has to fix the communication sector address before the communication starts; however, in order to prevent the communication sector address from being selected from the address range utilized by the file system of the computer system, the application program utilizes a big address, such as the last available sector address (e.g., 0xFFFFFFFF) of the master boot record (MBR) of the storage device or a sector address beyond the capacity of the storage device, to serve as the communication sector address, which leads to a compatibility problem. In addition, because the communication sector address may not be a legal sector address of certain system device controllers or operation systems, the communication will fail. Additionally, the above-mentioned in-band approach also has an extension problem, because the capacity of the storage device of the computer system expands day by day, and the fixed sector address will conflict with the sector address allocated to the file system when the fixed sector address is smaller than the capacity of the storage device. The fixed sector address may become an illegal direct access sector address, resulting in communication failure.

Furthermore, in the prior art design, another in-band communication approach utilizes the predetermined or preserved command which is predefined by the application program manufacturer to communicate with the storage device. This also has a compatibility problem. This is due to certain system device controllers being unable to support commands other than standard commands. In such cases, a custom driver must be added to solve the compatibility problem. According to the above-mentioned prior art techniques, realizing a high compatibility and high ductility communicating method of the storage device is an urgent issue.

### SUMMARY OF THE INVENTION

Therefore, one of the objectives of the present invention is to provide a communicating method which dynamically selects a block address in a storage device to act as a communicating means between the storage device and an application program.

According to an exemplary embodiment of the present invention, a communicating method between a storage device and an application program is provided. The method includes the following steps: the application program dynamically selects a block address in the storage device as a predetermined block address, and the application program performs the command write-in or state read-out processes via the predetermined block address to communicate with the storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a communicating method applied to a storage device according to an exemplary embodiment of the present invention.

FIG. 2 is a state diagram illustrating a predetermined control signal exchange procedure according to an exemplary embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

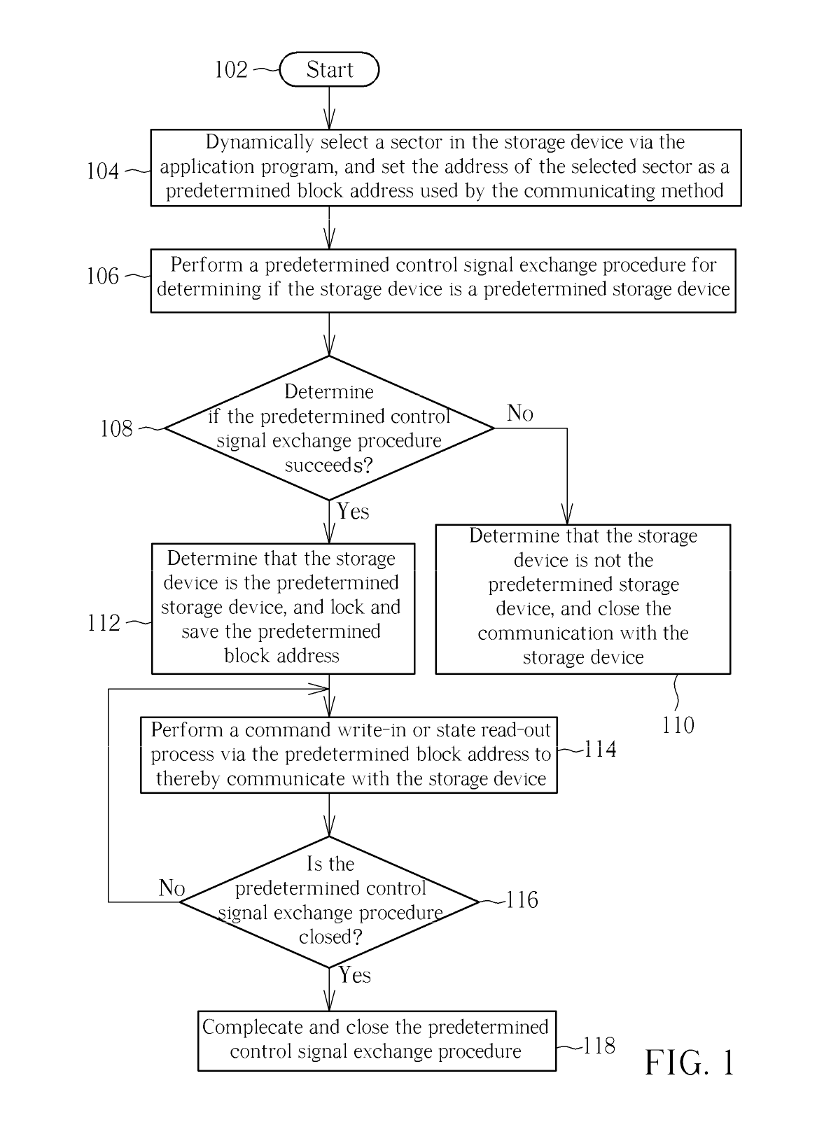

Please refer to FIG. 1. FIG. 1 is a flowchart illustrating a communicating method 100 applied to a storage device according to an exemplary embodiment of the present invention. In order to describe the spirit of the present invention more clearly, the communicating method 100 according to the exemplary embodiment of the present invention is illustrated using the exemplary communicating method between an application program and a hard disk apparatus; however, this is not meant to be a limitation to the scope of the present invention. In other words, under a condition where an operating system environment and a transmission interface are not limited, any application program that has the ability to perform reading/writing upon the sector data of the storage device can perform the communication through the communicating method 100. This also falls within the scope of the present invention. Please note that, provided that substantially the same result is achieved, the steps of the flow shown in FIG. 1 need not be in the exact order shown and need not be contiguous; that is, other steps can be intermediate. The communicating method 100 of the storage device comprises the following steps:

Step 102: Start.

Step 104: Dynamically select a sector in the storage device via the application program, and set the address of the selected sector as a predetermined block address used by the communicating method 100.

Step 106: Perform a predetermined control signal exchange procedure for determining if the storage device is a predetermined storage device.

Step 108: Determine if the predetermined control signal exchange procedure succeeds. If yes, proceed to step 112; otherwise, proceed to step 110.

Step 110: Determine that the storage device is not the predetermined storage device, and close the communication with the storage device.

Step 112: Determine that the storage device is the predetermined storage device, and lock and save the predetermined block address.

Step 114: When a control device of the storage device stays in a normal communication state, the control device performs a command write-in or state read-out process via the predetermined block address to thereby communicate with the storage device.

Step 116: Is the predetermined control signal exchange procedure closed? If yes, proceed to step 118; otherwise, return to step 114.

Step 118: Close the predetermined control signal exchange procedure, and enter a communication close state after closing the predetermined control signal exchange procedure.

In the communicating method 100 of the present invention, in order to perform the predetermined control signal exchange procedure, the application program will select a sector in the storage device, and then set the address of the selected sector as the predetermined block address (step 104), for performing the predetermined control signal exchange procedure. Please note that the afore-mentioned method used by the application program to select the predetermined block address is not meant to be taken as a limitation of the present invention. In other words, in another exemplary embodiment of the present invention, the application program analyzes the master boot record (MBR) or the GUID partition table (GPT) of the storage device to find the unused sector, and selects the address of the unused sector as the predetermined block address. Furthermore, in yet another exemplary embodiment of the present invention, the application program establishes a temporary file before performing the communication, and selects a block address, which is automatically allocated to the temporary file by the file system of a computer system, to serve as the predetermined block address. Please note that, for preserving the original data of the predetermined block address, the application program will perform read-out process to the predetermined block address, and back up the data content corresponding to the predetermined block address after the communicating method 100 of the present invention selects the predetermined block address. When the communicating method 100 of the present invention completes determining the predetermined control signal exchange procedure in step 108, the application program will restore the backup data content to the predetermined block address. Because when step 108 determines that the storage device is not the predetermined storage device, the predetermined block address will not be accessed. Conversely, when step 108 determines that the storage device is the predetermined storage device, the storage device will enter the normal communication state. In this time, all of the legal commands or predetermined exchange control signals will not be written into the predetermined block address.

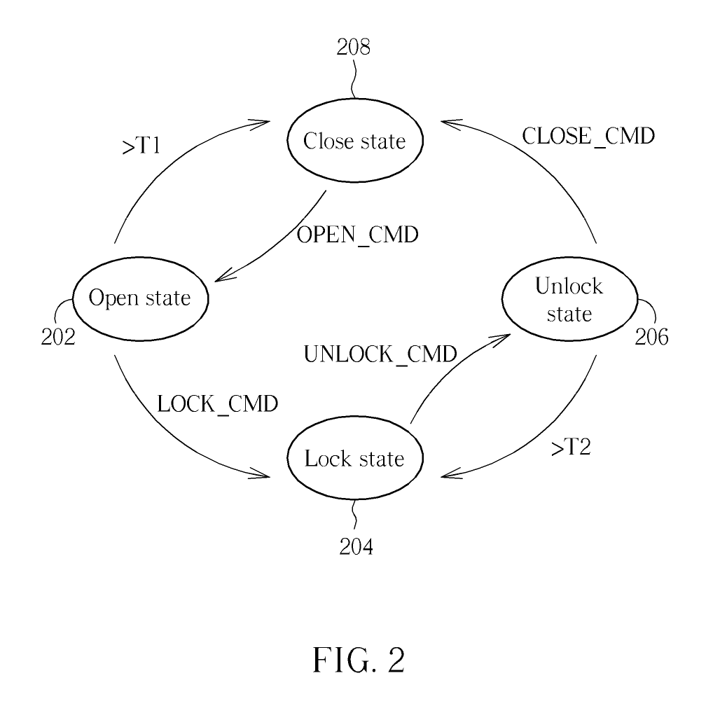

Then, in step 106, the application program performs the predetermined control signal exchange procedure with a control device of the storage device, for determining if the storage device is the predetermined storage device. Please refer to FIG. 2. FIG. 2 is a state diagram illustrating the predetermined control signal exchange procedure of the present invention. According to the exemplary embodiment of the present invention shown in FIG. 1, the predetermined control signal exchange procedure comprises four predetermined states, such as an open state 202, a lock state 204, an unlock state 206 and a close state 208. In the open state 202, the application program and the control device of the storage device stay in a “communication ready” state; in the lock state 204, the application program and the control device of the storage device stay in a “normal communication” state; in the unlock state 206, the application program and the control device of the storage device stay in a “communication close ready” state; and in the close state 208, the application program and the control device of the storage device stay in a “communication close” state. Please note that the predetermined control signal exchange procedure of the present invention has four states, but this is not meant to be a limitation of the present invention. In other words, the predetermined control signal exchange procedure of the present invention can be realized with any other number of states. For example, in another embodiment of the present invention, the predetermined control signal exchange procedure of the present invention is implemented using the lock state 204 and the close state 208 only. In yet another embodiment of the present invention, the predetermined control signal exchange procedure of the present invention is implemented using the open state 202, the lock state 204 and the close state 208 only. In another further embodiment of the present invention, the predetermined control signal exchange procedure of the present invention is implemented using the lock state 204, the unlock state 206 and the close state 208 only.

Please refer to FIG. 2 again. When the communicating method 100 of the present invention selects the predetermined block address, the application program and the control device of the storage device stay in the “communication close” state, i.e., the close state 208 shown in FIG. 2. In the close state 208, the application program cannot access the storage device, and the application program therefore has to send a first predetermined command to the control device for leaving the close state 208 and then entering the lock state 204, wherein the first predetermined command comprises a communication ready command OPEN_CMD and a normal communication command LOCK_CMD. The communication ready command OPEN_CMD is used for letting the control device enter the open state 202, and the normal communication command LOCK_CMD is used for letting the control device enter the lock state 204. Therefore, the control device switches from the close state 208 into the open state 202 when the control device of the storage device in the close state 208 receives the communication ready command OPEN_CMD. The control device starts counting a first time value T1 when the control device switches into the open state 202. To switch the control device from the open state 202 into the lock state 204, the application program has to transmit the normal communication command LOCK_CMD to the control device before the first time value T1 expires. According to the exemplary embodiment of the present invention, when the control device switches into the lock state 204, it means that the predetermined control signal exchange procedure of the step 106 is completed successfully. The storage device is identified as the predetermined storage device (step 112). Therefore, in the lock state 204 (step 114), the application program is allowed to perform the command write-in or state read-out processes via the predetermined block address to communicate with the storage device, and the application program can also access the storage device normally. Otherwise, if the control device does not receive the normal communication command LOCK_CMD issued from the application program before the first time value T1 expires, the control device will switch back to the close state 208 automatically after the first time value T1 expires, and then determine that the storage device is not the predetermined storage device, in order to close the communication with the storage device (step 110). Therefore, in accordance with the disclosed exemplary embodiment of the present invention, the back-out mechanism which utilizes the first time value T1 to limit the normal communication command LOCK_CMD write-in time can avoid the undesired consequence due to the data write-in accidentally fitting the data format of the communication ready command OPEN_CMD and changing the present state of the control device (i.e., the close state 208).

On the other hand, if the application program wants to close the lock state 204 of the storage device (step 116), the application program needs to send a second predetermined command to the control device for leaving the lock state 204 and then entering the close state 208, wherein the second predetermined command comprises a communication close ready command UNLOCK_CMD and a communication close command CLOSE_CMD. The communication close ready command UNLOCK_CMD is used for letting the control device enter the unlock state 206, and the communication close command CLOSE_CMD is used for letting the control device enter the close state 208. Therefore, when the control device of the storage device in the lock state 204 receives the communication close ready command UNLOCK_CMD, the control device switches from the lock state 204 into the unlock state 206. In addition, the control device starts counting a second time value T2 when the control device switches into the unlock state 206. To switch the control device from the unlock state 206 into the close state 208, the application program has to transmit the communication close command CLOSE_CMD to the control device before the second time value T2 expires. According to the exemplary embodiment of the present invention, when the control device switches into the close state 208, it means that the application program can access the storage device no longer (step 118). Otherwise, if the control device does not receive the communication close command CLOSE_CMD issued from the application program before the second time value T2 expires, the control device will switch back to the lock state 204 automatically after the second time value T2 expires. Therefore, in accordance with the disclosed embodiment of the present invention, the back-out mechanism which utilizes the second time value T2 to limit the communication close command CLOSE_CMD write-in time can avoid the undesired consequence due to the data write-in accidentally fitting the data format of the communication close ready command UNLOCK_CMD and then changing the present state of the control device (i.e., the lock state 204).

Furthermore, the control device locks the predetermined block address and starts a single address tracking of the predetermined block address when the predetermined control signal exchange procedure enters the lock state 204 successfully. That is, the control device will determine if the received data is a legal command which is issued from the application program when the storage device performs a write-in procedure to the predetermined block address. If the received data is the legal command, the legal command is performed. On the other hand, if the received data is not the legal command, the received data are directly written into the predetermined block address. In other words, the control device will determine the predetermined block address and the fitted transmission length of the received data, and then determine if the received data is one of the above-mentioned commands: the communication ready command OPEN_CMD, the normal communication command LOCK_CMD, the communication close ready command UNLOCK_CMD and the communication close command CLOSE_CMD. When the predetermined block address and the length of the received data are fitted, the control device will further determine if the received data is a legal writing command. On the other hand, when the predetermined block address or the length of the received data is not fitted, the application program also saves the predetermined block address to serve as the transmission address of the following writing/reading processes to complete the mechanism of locking and saving the predetermined block address.

The communicating method 100 of the present invention can perform command write-in or state read-out of the control device via the predetermined block address after the application program successfully identifies the predetermined block address. According to the exemplary embodiment of the present invention, the write-in and read-out mechanism prevents the unknown write-in and read-out operation from affecting the mechanism defined by the predetermined control signal exchange procedure shown in FIG. 2 and followed by the application program and the storage device. The application program has to perform the write-in process to each predetermined block address before the read-out process is initiated, and the write-in data must be a legal command to make the control device prepare an executing result in response to the legal command. Then, the control device sends the executing result back to the application program when the application program performs a state read-out operation via the predetermined block address. Thus, the communication between the application program and the storage device will be completed normally. Please note that, according to the exemplary embodiment of the present invention, the write-in data and the executing result will not actually be written into the predetermined block address of the storage device, but instead will be temporarily written into a memory storage disposed in the control device. Furthermore, if the application program fails to perform a legal command write-in process before reading out the state of the control device, the control device will send the data in the storage device which corresponds to the predetermined block address back to the application program. Thus, the write-in and read-out mechanism for non command write-in and non state read-out operations can allow other application programs to complete the data access of the predetermined block address normally.

Furthermore, when the first application program performs a command write-in or state read-out processes via the predetermined block address to communicate with the storage device, the control device will also check if the block address is currently accessed by a second application program besides the first application program. The control device reports this situation to the application program when the block address is currently accessed by a second application program besides the first application program, and then the application program selects a new block address again to communicate with the storage device for completing an address alternation mechanism (i.e., executing steps of the communicating method 100 again). Therefore, the application program of the present invention can dynamically select the predetermined block address to communicate with the storage device. In other words, in order to determine if the predetermined block address is currently accessed by a second application program besides the first application program, when the predetermined block address and the length of the received data are fitted, the control device will not only determine if the received data is one of the above-mentioned commands: the communication ready command OPEN_CMD, the normal communication command LOCK_CMD, the communication close ready command UNLOCK_CMD and the communication close command CLOSE_CMD, but also determine if the received data is a legal writing command. Please note that, as those skilled in the art can readily appreciate the operational steps directed to the address alternation mechanism after reading the embodiment disclosed by FIG. 1 and FIG. 2 of the present invention, detailed description is omitted here for the sake of brevity.

In summary, the communicating method 100 of a storage device of the present invention has high compatibility and good extension, and can therefore alternatively change the sector address in the effective sector address range of a storage device, and the selected sector address can be successfully used, as no confliction with illegal address occurs. In addition, the method of the present invention will not face the problem of sector address extension when the capacity of the storage device is increased. The communicating method 100 of the present invention is also not limited to the operation system of a computer and the transmission interface of the storage device; therefore, as long as the application program can perform the process of reading/writing a sector under the operation system, it can establish the communication protocol with the storage device. Furthermore, when the application program performs a command write-in or state read-out processes to the predetermined block address, it will not actually perform writing upon the corresponding block in the storage device, but will instead temporarily write to a memory storage in the control device of the storage device. In this way, the communicating method 100 of the present invention will be faster and more effective than the prior art design.

Those skilled in the art will readily observe that numerous modifications and alterations of the device and method may be made while retaining the teachings of the invention.

What is claimed is:

1. A communicating method for a storage device, comprising:
(a) dynamically selecting a block address in the storage device; and
(b) performing a command write-in or state read-out process via the predetermined block address to thereby communicate with the storage device.

2. The method of claim 1, further comprising:
performing a predetermined control signal exchange procedure with the storage device, for determining if the storage device is a predetermined storage device;
wherein the step (b) is performed after the storage device is determined to be the predetermined storage device.

3. The method of claim 2, wherein the predetermined control signal exchange procedure comprises:
writing at least a first predetermined command into the storage device, wherein the first predetermined command is for letting the predetermined storage device enter a predetermined state; and
determining if the storage device is in the predetermined state to determine if the storage device is the predetermined storage device, wherein when the storage device is in the predetermined state, the storage device is determined to be the predetermined storage device.

4. The method of claim 3, wherein the predetermined state is a normal communication state, the step (b) is performed when the storage device is in the normal communication state, and the method further comprises:
switching the predetermined storage device from a communication close state into the normal communication state when the predetermined storage device in the communication close state receives the first predetermined command; and
switching the predetermined storage device from the normal communication state into the communication close state when the predetermined storage device in the normal communication state receives at least a second predetermined command.

5. The method of claim 4, wherein the first predetermined command comprises a communication ready command and a normal communication command, the communication ready command is used for letting the predetermined storage device enter a communication ready state, the normal communication command is used for letting the predetermined storage device enter the normal communication state, and the step of switching the predetermined storage device from the communication close state into the normal communication state comprises:
switching the predetermined storage device from the communication close state into the communication ready state when the predetermined storage device in the communication close state receives the communication ready command;
starting counting a time value when the predetermined storage device enters the communication ready state;
switching the predetermined storage device from the communication ready state into the normal communication state when the predetermined storage device in the communication ready state receives the normal communication command during the time value; and
switching the predetermined storage device from the communication ready state into the communication close state when the predetermined storage device does not receive the normal communication command during the time value.

6. The method of claim 4, wherein the second predetermined command comprises a communication close ready command and a communication close command, the communication close ready command is used for letting the predetermined storage device enter a communication close ready state, the communication close command is used for letting the predetermined storage device enter the communication close state, and the step of switching the predetermined storage device from the normal communication state into the communication close state comprises:
switching the predetermined storage device from the normal communication state into the communication close ready state when the predetermined storage device in the normal communication state receives the communication close ready command;
starting counting a time value when the predetermined storage device enters the communication close ready state;
switching the predetermined storage device from the communication close ready state into the communication close state when the predetermined storage device in the communication close ready state receives the communication close command during the time value; and
switching the predetermined storage device from the communication close ready state into the normal communication state when the predetermined storage device does not receive the communication close command during the time value.

7. The method of claim 1, wherein the step (a) comprises:
setting the block address according to an address corresponding to an unused storage block of the storage device.

8. The method of claim 7, wherein the step of setting the block address comprises:
analyzing a disk partition table of the storage device to search an unused sector specified in the disk partition table; and
setting the block address according to a sector address of the unused sector.

9. The method of claim 1, wherein the step (a) comprises:
establishing a temporary file in the storage device; and
setting the block address according to an address allocated to the temporary file.

10. The method of claim 1, wherein the step (b) comprises:
determining if received data is a legal command when the storage device performs a write-in procedure to the block address;
performing the legal command when the received data is the legal command; and
writing the received data into the block address when the received data is not the legal command.

11. The method of claim 1, wherein the step (b) comprises:
when the storage device performs a read-out procedure to the block address, determining if a legal command is performed during the storage device performing a write-in procedure to the block address before the storage device performs the read-out procedure;
returning an executing result of the legal command if the legal command is performed when the storage device performs the write-in procedure to the block address; and
returning data content stored at the block address if the legal command is not performed when the storage device performs the write-in procedure to the block address.

12. The method of claim 1, wherein a first application program performs a command write-in or state read-out process via the block address to communicate with the storage device, and the method further comprises:
checking if the block address is currently accessed by a second application program besides the first application program when the first application program wants to perform the command write-in or state read-out process via the block address to communicate with the storage device; and
performing the step (a) and step (b) again to select another block address for allowing the first application program to perform the command write-in or state read-out process via the other block address to communicate with the storage device when the block address is currently accessed by the second application program besides the first application program.
